(19) United States
(12) Patent Application Publication
(10) Pub. No.: US 2024/0136602 A1
(43) Pub. Date: Apr. 25, 2024

(54) CONSUMER ELECTRONIC DEVICE, BATTERY MODULE, AND START METHOD OF CONSUMER ELECTRONIC DEVICE AT LOW TEMPERATURE

(71) Applicant: Getac Technology Corporation, New Taipei (TW)

(72) Inventors: CHUI-HSIEN LI, Taipei (TW); CHIN-JUNG CHANG, Taipei (TW)

(21) Appl. No.: 18/101,628

(22) Filed: Jan. 26, 2023

(30) Foreign Application Priority Data
Oct. 19, 2022 (CN) 202211287635.5

(51) Int. Cl. H01M 10/42; H01M 10/48; H01M 10/615; H01M 10/623

(52) U.S. Cl. CPC H01M 10/425; H01M 10/486; H01M 10/615; H01M 10/623; H01M 2010/4271; H01M 2010/4278; H01M 2220/20

(57) ABSTRACT

A consumer electronic device includes a battery module and a system chip. The battery module includes: battery cells, a heater adjacent to the battery cells, a battery management circuit coupled to the battery cells and the heater, and an electrical connector including an information transmission interface and a power transmission interface. The information transmission interface is coupled to the battery management circuit, and the power transmission interface is coupled to the battery cells. The system chip is coupled to the information transmission interface, and is configured to receive battery information from the battery management circuit through the information transmission interface. When a battery temperature of the battery information is lower than a first threshold, the system chip sends an activation signal to the battery management circuit through the information transmission interface, for the battery management circuit to activate the heater according to the activation signal.

### CROSS-REFERENCE TO RELATED APPLICATIONS

The application claims priority to Chinese Patent Application No. 202211287635.5, filed on Oct. 20, 2022, the disclosure of which is hereby incorporated by reference herein in its entirety.

### BACKGROUND OF THE INVENTION

### Field of the Invention

The present invention relates to the field of electronics, and more particularly, to a consumer electronic device, a battery module and a start method of a consumer electronic device at a low temperature.

### Description of the Prior Art

Consumer electronic products usually use lithium batteries, which are extensively applied in cellphones, tablet computers and laptop computers due to the large capacity, high density and small volume of the lithium batteries. However, under a low temperature, the viscosity of the electrolyte inside the battery increases as the temperature lowers, thereby affecting the mobility of lithium ions such that the discharging performance of the battery at a low temperature is degraded. Taking an example of an electrical capacity of 4999 mAh and a cut-off discharge voltage of 3.0 V for instance, the battery capacity is 100% at 23 degrees Celsius. However, only 60% of the capacity remains at −10 degrees Celsius. When the battery is drawn at 0.2C, only 50% is left at −21 degrees Celsius. When the battery is drawn at 0.5C, the battery voltage drops to 3V after about two hours at 25 degrees Celsius. However, at −21 degrees Celsius, the battery can hardly maintain a voltage output of 3.0 V.

Thus, the above issue is extremely unfavorable for applications of consumer electronic products at a low temperature; that is, the standby time and the time of use are significantly shortened, the electrical capacity is consumed faster at a low temperature, and an activation failure of the consumer electronic products may result, hence significantly affecting the functions of the consumer electronic products.

There is currently an approach of using a heater to improve the fluidity of the electrolyte. For a heater disposed inside a consumer electronic product, a large amount of modifications needs to be made to the circuits and transmission specifications in order to actuate the heater. If an external heater is used, the heater and the power supply may need to be carried by the user, resulting in portability inconveniences.

### SUMMARY OF THE INVENTION

In one embodiment, a consumer electronic device includes a battery module and a system chip. The battery module includes battery cells, a heater, a battery management circuit and an electrical connector. The heater is adjacent to the battery cells, and heats the battery cells. The battery management circuit is coupled to the battery cells and the heater. The electrical connector includes an information transmission interface and a power transmission interface. The information transmission interface is coupled to the battery management circuit, and the power transmission interface is coupled to the battery cells. The system chip is coupled to the information transmission interface, and is configured to receive battery information from the battery management circuit through the information transmission interface. When a battery temperature of the battery information is lower than a first threshold, the system chip sends an activation signal to the battery management circuit through the information transmission interface, for the battery management circuit to activate the heater according to the activation signal.

In some embodiments, the information transmission interface includes an existence pin and a data pin. The existence pin is coupled to the battery management circuit and the system chip, and is configured to output a battery existence signal to the system chip. The data pin is coupled between the battery management circuit and the system chip, and is configured to output battery information to the system chip.

In some embodiments, the consumer electronic product further includes a power supply circuit. The power supply circuit is electrically connected to the system chip, and is configured to supply power to the system chip and the power transmission interface. The battery module may be a removable battery. The system chip receives the battery existence signal through the existence pin to the battery management circuit, and determines that the power transmission interface is electrically connected to the power supply circuit upon detecting the battery existence signal.

In some embodiments, the battery management circuit further includes a battery management chip and a power switch. The battery management chip is coupled to the data pin, and is configured to generate the battery information according to a state of the battery cells. The power switch is coupled to the existence pin, and is coupled between the battery cells and the heater. Accordingly, the power switch connects the battery cells to the heater in response to the activation signal, so as to activate the heater.

In some embodiments, the battery management circuit further includes a level circuit, which is coupled to the existence pin so as to pull the level of the existence pin to a given level.

In some embodiments, the first threshold is −10 to 0 degrees Celsius.

In some embodiments, after the heater is activated, the system chip further receives the battery information from the battery management circuit through the data pin again. When the battery temperature of the battery information received again is higher than a second threshold, the system chip sends a stop signal to the battery management circuit through the existence pin, for the battery management circuit to stop the heater according to the stop signal.

In some embodiments, the second threshold is 10 to 25 degrees Celsius.

In one embodiment, a battery module includes battery cells, a heater, a battery management circuit, an electrical connector and a battery management circuit. The battery is configured to store power. The heater is adjacent to the battery cells, and heats the battery cells. The battery management circuit is coupled to the battery cells and the heater. The electrical connector includes an existence pin, a data pin and a power pin. The existence pin is coupled to the power management circuit, and is configured to receive an activation signal. The data pin is coupled to the battery management circuit, and is configured to output battery information. The power pin is coupled to the battery cells, and is configured to input and output power. The battery management chip is electrically coupled to the battery cells, the heater and the data pin, and is configured to generate the battery information according to a state of the battery cells, and the battery management circuit is further configured to activate the heater according to the activation signal.

In some embodiments, the battery module further includes a battery management hip and a power switch. The battery management chip is coupled to the data pin, and is configured to generate the battery information according to a state of the battery cells. The power switch is coupled to the existence pin and is coupled between the battery cells and the heater. The power switch connects the battery cells to the heater in response to the activation signal, so as to activate the heater.

In one embodiment, a start method of a consumer electronic product at a low temperature includes: receiving battery information of a battery module through a data pin of the battery module; comparing a battery temperature of the battery information with a first threshold; when the battery temperature is lower than the first threshold, sending an activation signal to the battery module through an existence pin, so as to start a heater built in the battery module; receiving the battery information of the battery module through the data pin again; and performing a start-up procedure of the consumer electronic product under power supplied by the battery module when the battery temperature of the battery information received agaom is higher than the first threshold.

In some embodiments, the first threshold is −10 to 0 degrees Celsius.

In some embodiments, the start method of a consumer electronic product further includes: before receiving the battery information of the battery module through the data pin of the battery module, detecting a battery existence signal from the existence pin.

In some embodiments, the start method of a consumer electronic product further includes: after the heater is activated, receiving the battery information of the battery module through the data pin of the battery module again; comparing the battery temperature of the battery information with a second threshold; and when the battery temperature of the battery information received again is higher than the second threshold, sending a stop signal to the battery management circuit through the existence pin, for the battery management circuit to stop the heater according to the stop signal. More specifically, inn some embodiments, the second threshold is 10 to 25 degrees Celsius.

It can be understood from the above embodiments that, by performing bi-directional transmissions with an existing information transmission interface between the system chip and the battery module, start control of the heater that satisfies the specifications of an output/input interface of an originally designed battery module can be achieved without altering the specifications, or the overall battery module is heated by an external heating means to increase the temperature of the battery cells.

### BRIEF DESCRIPTION OF THE DRAWINGS

FIG. 1 is a block schematic diagram of a consumer electronic device according to one embodiment;

FIG. 2 is a perspective diagram of an example of the battery module in FIG. 1;

FIG. 3 is a circuit diagram of a battery module according to one embodiment; and

FIG. 4 is a flowchart of a start method of a consumer electronic device at a low temperature according to one embodiment.

### DETAILED DESCRIPTION OF THE EMBODIMENTS

For better clarity, widths of some elements and areas in the drawings are scaled up. Throughout of the description, the same numerals and symbols in the drawings represent the same elements.

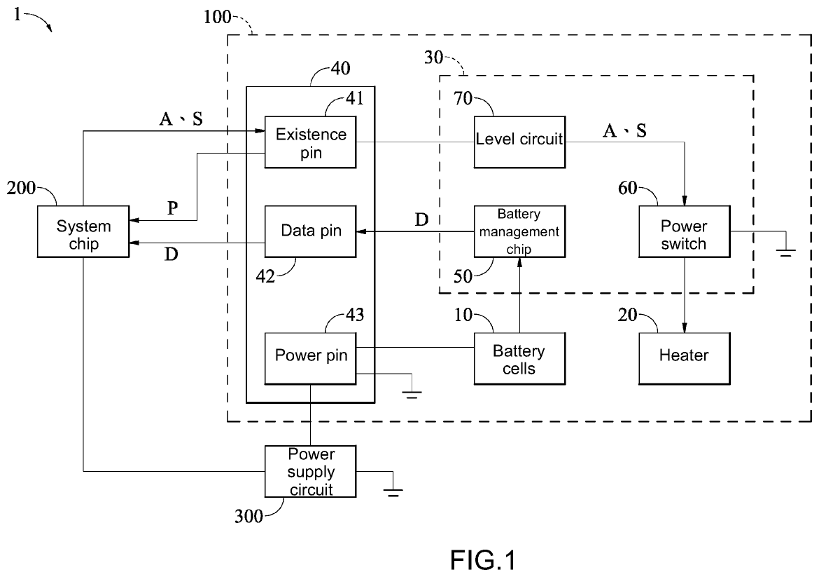

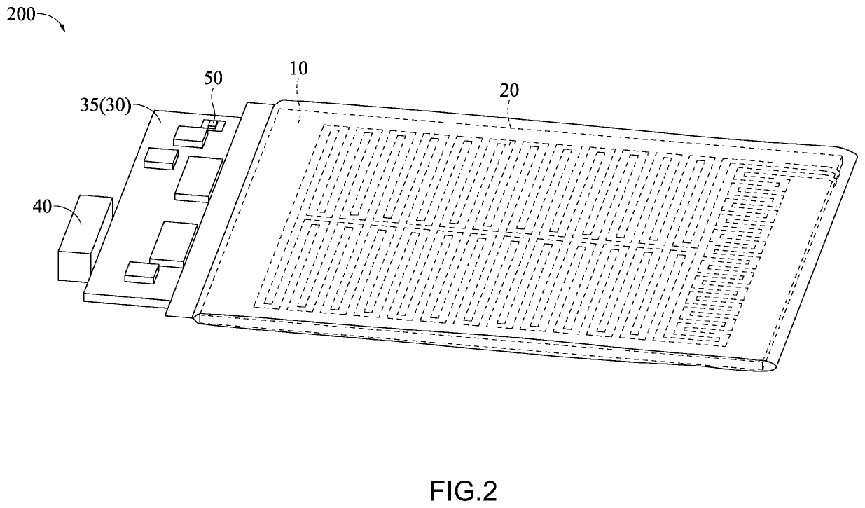

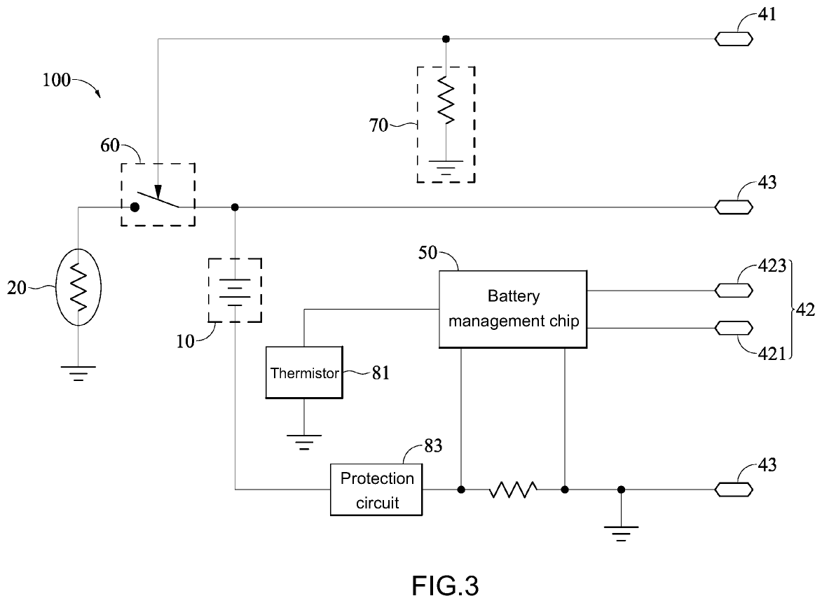

FIG. 1 shows a block schematic diagram of a consumer electronic device according to one embodiment. FIG. 2 shows a perspective diagram of an example of the battery module in FIG. 1. FIG. 3 shows a circuit diagram of a battery module according to an embodiment. As shown in FIG. 1 to FIG. 3, a consumer electronic device 1 includes a battery module 100 and a system chip 200. The battery module 100 includes battery cells 10, a heater 20, a battery management circuit 30 and an electrical connector 40. The heater 20 is adjacent to the battery cells 10, and is configured to heat the battery cells 10. Herein, FIG. 2 depicts that the heater 20 envelops the outside of the battery cells 10; however, this is merely and example and is not to be construed as a limitation. For example, in response to actual requirements, the heater 20 may also be directly adhered to an upper surface or a lower surface of the battery cells 10.

The battery management circuit 30 is coupled to the battery cells 10 and the heater 20. The electrical connector 40 includes an information transmission interface and a power transmission interface. The information transmission interface includes an existence pin 41, and one or more data pins 42 (for example, a system clock pin 421 and a system data pin 423). The existence pin 41 and the data pin 42 are coupled to the battery management circuit 30. The power transmission interface includes a pair of power pins 43 (for example, a positive electrical pin and a negative electrical pin). Herein, FIG. 1 depicts only one single power pin 43 and one single data pin 42 for better understanding. The power pin 43 is coupled to the battery cells 10. The system chip 200 is coupled to the existence pin 41 and the data pin 42, and receives battery information D from the battery management circuit 30 through the data pin 42. When a battery temperature of the battery information D is lower than a first threshold, the system chip 200 sends an activation signal A to the battery management circuit 30 through the existence pin 41, for the battery management circuit 30 to activate the heater 20 according to the activation signal A.

Thus, by performing bi-directional transmissions with an existing information transmission interface between the system chip 200 and the battery module 100, start control of the heater 20 that satisfies the specifications of an output/input interface of an originally designed battery module 100 can be achieved without altering the specifications, or the overall battery module 100 is heated by an external heating means to increase the temperature of the battery cells 10.

Again referring to FIG. 1, the consumer electronic device 1 further includes a power supply circuit 300. The power supply circuit 300 is electrically connected to the system chip 200, and is configured to supply power to the system chip 200. In other words, the power supply circuit 300 can draw electrical power stored in the battery cells 10 through the power pin 43, accordingly adjust the electrical power to a level needed by the system chip 200 and supply the electrical power to the system chip 200.

In some embodiment, the battery module 100 is a removable battery, and is removeably assembled on a body of the consumer electronic device 1. Herein, the system chip 200 further confirms through the existence pin 41 whether the battery module 100 is assembled on the body of the consumer electronic device 1, that is, determining whether the power pin 43 is electrically connected to the power supply circuit 300. When the battery module 100 is assembled on the body of the consumer electronic device 1, the existence pin 41 outputs a battery existence signal P, and thus the system chip 200 can determine, by detecting the battery existence signal P from the existence pin 41, that the power pin 43 is connected to the power supply circuit 300. That is to say, when the system chip 200 detects the battery existence signal P, the system chip 200 can accordingly determine that the power pin 43 and the power supply circuit 300 are electrically connected.

In some embodiments, the battery management circuit 30 may further include a level circuit 70. The level circuit 70 is configured to pull a level of the existence pin 41 to a given potential (that is, the battery existence signal P). In some embodiments, the level circuit 70 may include an impedance element coupled between the existence pin 41 and a ground, wherein the impedance element may be a resistor. More specifically, upon detecting the battery existence signal P from the existence pin 41, that is, determining that the power pin 43 is electrically connected to the power supply circuit 300, the battery management circuit 30 switches the voltage at the existence pin 41 to a low voltage level through the level circuit 70, and switches the existence pin 41 to an output mode.

Again referring to FIG. 1 and FIG. 2, the battery management circuit 30 may further include a battery management chip 50 and a power switch 60. The battery management chip 50 is coupled to the data pin 42, and is configured to generate the battery information D according to a state of the battery cells 10. For example, the battery management chip 50 obtains the battery information D by controlling charging/discharging of the battery cells 10, that is, detecting the state of the battery cells 10. For example, the battery information D includes a battery temperature, a capacity and a time of use, and is provided to the system chip 200 for determination. The power switch 60 is coupled to the existence pin 41, and is coupled between the battery cells 10 and the heater 20. Accordingly, the power switch 60 connects the battery cells 10 and the heater 20 in response to the activation signal A, so as to activate the heater 20. For example, the power switch 60 is normally off. When the power switch 60 is controlled by the activation signal A, that is, when the activation signal A is received, the power switch 60 switches from off to on, so as to electrically connect the power cells 10 to the heater 60 through the power switch 60, that is, power is supplied to the heater 20.

As shown in FIG. 3, in one embodiment, the battery management chip 50 can be implemented by a gauge integrated circuit (IC), and calculate the battery temperature by using a thermistor 81. A protection circuit 83 may further be provided between the battery cells 10 and the power pin 43, so as to prevent damage of the battery cells 10 caused by surges or an overly large voltage.

In some embodiments, the switch 60 may be implemented by a MOS or other types of transistors, and the system chip 200 turns on the power switch 60 by applying a voltage of a predetermined level (that is, the activation signal A).

In some embodiments, the electrical connector 40, the power switch 60, and the power supply circuit 300 are further coupled to the ground.

Again referring to FIG. 1 and FIG. 3, although not shown in the drawings, a person skill in the art would be able to understand that the number of the data pins 42 may correspond to system specifications. Assuming that the communication interface between the system chip 200 and the battery module 100 is SM Bus, the data pin 42 may be provided in a pair, that is, the system clock pin 421 and the system data pin 423. The system chip 200 is coupled to the system clock pin 421 of the electrical connector 40, and transmits a system clock signal (for example, SM Bus clock) with an external system through the system clock pin 421. Moreover, the system chip 200 is coupled to the data clock pin 423 of the electrical connector 40, and transmits a data clock signal (for example, SM Bus data) with an external system through the data clock pin 423. In other words, the battery management chip 50 further receives the system clock signal and the system data signal from the system chip 200, accordingly converts the state of the battery module 100 detected into the system clock signal and the system data signal, and transmits system clock signal and the system data signal to the system chip 200 through the system clock pin 421 and the system data pin 423.

Referring to FIG. 2, the battery cells 10, the electrical connector 40 and the battery management chip 50 are in fact mounted on a circuit board 35 and are packaged into a removable battery. The power supply circuit 300 and the system chip 200 are formed on a motherboard of the consumer electronic device 1 and are electrically connected to the electrical connector 40 of the removable battery through the corresponding electrical connector 40.

In some embodiments, the system chip 200 further receives the battery information D of the battery management circuit 30 through the data pin 42 again. When the battery temperature of the battery information D received again is higher than the second threshold, the system chip 200 sends a stop signal S (for example, to stop outputting the activation signal A) to the battery management circuit 30 through the existence pin 41, for the battery management circuit 30 to stop the heater 20 according to the stop signal S. For example, when the system chip 20 does not output the activation signal A, the level of the existence pin 41 is pulled down to a first potential because of the level circuit 70. At this point, a control terminal of the power switch 60 is at the first potential because being coupled to the existence pin 41, so that the state of the power switch 60 is off due to the first potential. When the system chip 20 outputs the activation signal A having a second potential, the level of the existence pin 41 is pulled up to the second potential because of the activation signal A. At this point, the control terminal of the power switch 60 rises from the first potential to the second potential because being coupled to the existence pin 41, so that the state of the power switch 60 is switched to on. In other words, the activation signal A and the stop signal S may be at the second potential and the first potential, respectively, wherein the second potential is greater than the first potential.

In some embodiments, the first threshold is −10 to 0 degrees Celsius, preferably −5 to 0 degrees Celsius; and the second threshold is 10 to 25 degrees Celsius, and preferably 15 to 23 degrees Celsius. The numerical values above are merely example and are not to be construed as limitations. In practice, adjustment or setting may be made by taking into account the type, battery capacity and application environment of the consumer electronic device 1.

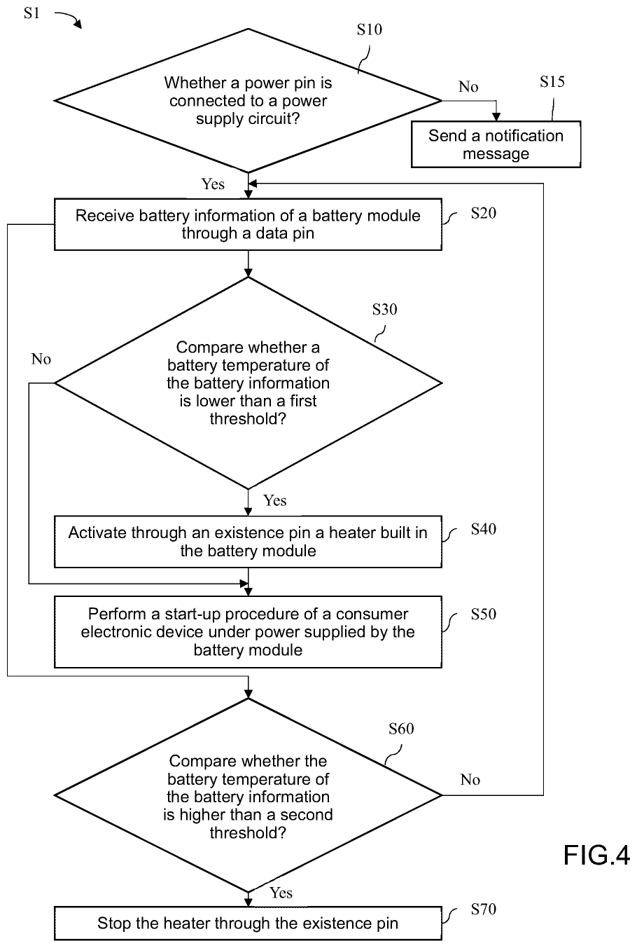

FIG. 4 shows a flowchart of a start method of a consumer electronic device at a low temperature according to one embodiment. As shown in FIG. 3 and also referring to FIG. 1, a start method Si of at a consumer electronic product at a low temperature includes: step S20 of receiving the battery information D of the battery module 100 through the data pin 42 of the battery module 100; step S30 of comparing the battery temperature of the battery information D with a first threshold, and proceeding to step S40 when the battery temperature is lower than the first threshold, or proceeding to step S50 when the battery temperature is lower than the first threshold or when the temperature in the battery information D received again from the battery module 100 through the data pin 42 is higher than the first threshold; step S40 of switching the existence pin 41 to output and send the activation signal A to the battery module 100 through the existence pin 41, so as to start the heater 20 built in the battery module 100; and step S50, performing a start-up procedure of the consumer electronic device 1 under power supplied by the battery module 100.

More specifically, in step S40, the activation signal A may be a pulse width modulation (PWM) signal; in some embodiments, an output ratio of the PWM signal may be further adjusted according to the battery temperature. For example, the output ratio of the PWM signal is directly proportional to the battery temperature in Celsius, and the output ratio is a positive value. In some embodiments, the output ratio alpha (α) is “battery temperature in Celsius/−29), and 0<α<1.

In some embodiment, before step S20, the start method Si of a consumer electronic device further includes: step S10 of the system chip 200 detecting the battery existence signal P from the existence pin 41, and determining whether the power pin 43 of the battery module 100 is electrically connected to the power supply circuit 300. Step 15 is performed if the system chip 200 does not detect the battery existence signal P for a continuous period of time and determines that the power pin 43 is not electrically connected to the power supply circuit 300. In step S15, a notification message is sent, for example, displaying information indicating that the battery is not electrically connected on a display screen.

In some embodiments, after step S40, the start method 51 of a consumer electronic product further returns to step S20 of receiving the battery information D of the battery module 100 through the data pin 42 of the battery module 100 again. Moreover, the start method 51 further includes step S60 of comparing the battery temperature of the battery information D with the second threshold in the battery information D, and proceeding to step S70 when the battery temperature of the battery information D received again is higher than the second threshold; and step S70 of sending the stop signal S to the battery management circuit 30 through the existence pin 41, for the battery management circuit 30 to stop the heater 20 according to the stop signal S.

In conclusion, by performing bi-directional transmissions with an existing information transmission interface between the system chip 200 and the battery module 100, start control of the heater 20 that satisfies the specifications of an output/input interface of an originally designed battery module 100 can be achieved without altering the specifications, or the overall battery module 100 is heated by an external heating means to increase the temperature of the battery cells 10.

The present invention is disclosed as the embodiments above. However, these embodiments are not to be construed as limitation to the present invention. Slight modifications and variations may be made by a person skilled in the art without departing from the spirit and scope of the present invention. Therefore, these modifications and variations are to be encompassed within the scope of the claims of the present invention.

What is claimed is:

1. A consumer electronic device, comprising:
a battery module, comprising:
a battery cell;
a heater, adjacent to the battery cell, configured to heat the battery cell;
a battery management circuit, electrically coupled to the battery cell and the heater; and
an electrical connector, comprising:
an information transmission interface, coupled to the battery management circuit; and
a power transmission interface, coupled to the battery cell; and
a system chip, coupled to the information transmission interface, configured to receive a battery information of the battery management circuit through the information transmission interface,
wherein when a battery temperature of the battery information is lower than a first threshold, the system chip sends an activation signal to the battery management circuit through the information transmission interface, for the battery management circuit to activate the heater according to the activation signal.

2. The consumer electronic device according to claim 1, wherein the information transmission interface comprises:
an existence pin, coupled to the battery management circuit and the system chip, configured to output a battery existence signal to the system chip; and
a data pin, coupled between the battery management circuit and the system chip, configured to output battery information to the system chip.

3. The consumer electronic device according to claim 2, further comprising:
a power supply circuit, electrically connected to the system chip, configured to supply power to the system chip and the power transmission interface;
wherein, the battery module is a removable battery, and
wherein the system chip receives the battery existence signal through the existence pin, and determines that the power transmission interface is electrically connected to the power supply circuit upon receiving the battery existence signal.

4. The consumer electronic device according to claim 2, wherein the battery management circuit further comprises:
a battery management chip, coupled to the data pin, configured to generate the battery information according to a state of the battery cell; and
a power switch, coupled to the existence pin and coupled between the battery cells and the heater, configured to connect the battery cell to the heater in response to the activation signal, so as to activate the heater.

5. The consumer electronic device according to claim 2, wherein the battery management circuit further comprises:
a level circuit, coupled to the existence pin so as to pull the level of the existence pin to a given level.

6. The consumer electronic device according to claim 1, wherein the first threshold is −10 to 0 degrees Celsius.

7. The consumer electronic device according to claim 2, wherein after the heater is activated, the system chip further receives the battery information of the battery management circuit through the existence pin again, and sends a stop signal to the battery management circuit through the existence pin when the battery temperature of the battery information received again is higher than a second threshold, for the battery management circuit to stop the heater according to the stop signal.

8. The consumer electronic device according to claim 7, wherein the second threshold is 10 to 25 degrees Celsius.

9. A battery module, comprising:
a battery cell, configured to store power;
a heater, adjacent to the battery cell, configured to heat the battery cell;
an electrical connector, comprising:
an existence pin, configured to receive an activation signal;
a data pin, configured to output battery information; and
a power pin, coupled to the battery cell, configured to input and output the power; and
a battery management circuit, electrically coupled to the battery cell, the heater, the existence pin and the data pin, configured to generate the battery information according to a state of the battery cell, wherein the battery management circuit is further configured to activate the heater according to the activation signal.

10. The battery module according to claim 9, wherein the battery management circuit comprises:
a battery management chip, coupled to the data pin, configured to generate the battery information according to a state of the battery cell; and
a power switch, coupled to the existence pin and coupled between the battery cells and the heater, configured to connect the battery cell to the heater in response to the activation signal, so as to activate the heater.

11. A start method of a consumer electronic device at a low temperature, comprising:
receiving battery information of a battery module through a data pin of the battery module;
comparing a battery temperature of the battery information with a first threshold;
when the battery temperature is lower than the first threshold, sending an activation signal to the battery module through an existence pin, so as to activate a heater built in the battery module;
receiving the battery information of the battery module through the data pin again; and
when the battery temperature of the battery information received again is higher than the first threshold, performing a start-up procedure of a consumer electronic device under power supplied by the battery module.

12. The start method of a consumer electronic device at a low temperature according to claim 11, wherein the first threshold is −10 to 0 degrees Celsius.

13. The start method of a consumer electronic device at a low temperature according to claim 11, further comprising:
before receiving the battery information of the battery module through the data pin of the battery module, detecting a battery existence signal from the existence pin.

14. The start method of a consumer electronic device at a low temperature according to claim 11, further comprising:
after the heater is activated, receiving the battery information of the battery module through the data pin of the battery module again;
comparing the battery temperature of the battery information with a second threshold; and
when the battery temperature of the battery information received again is higher than a second threshold, sending a stop signal to the battery management circuit through the existence pin, for the battery management circuit to stop the heater according to the stop signal.

15. The start method of a consumer electronic device at a low temperature according to claim 14, wherein the second threshold is 10 to 25 degrees Celsius.
